(19) United States
(12) Patent Application Publication
(10) Pub. No.: US 2017/0149560 A1
(43) Pub. Date: May 25, 2017

(54) DIGITAL BLOCKCHAIN AUTHENTICATION

(71) Applicant: Netspective Communications LLC, Silver Spring, MD (US)

(72) Inventor: Shahid N. Shah, Silver Spring, MD (US)

(73) Assignee: Netspective Communications LLC, Silver Spring, MD (US)

(21) Appl. No.: 15/427,806

(22) Filed: Feb. 8, 2017

Related U.S. Application Data
(63) Continuation-in-part of application No. 13/756,433, filed on Jan. 31, 2013.
(60) Provisional application No. 61/594,216, filed on Feb. 2, 2012.

(51) Int. Cl. H04L 9/06; H04L 29/06; G06K 7/14; G06T 7/10; G10L 17/08; H04L 9/32; G06K 9/00

(52) U.S. Cl. CPC H04L 9/0637; H04L 9/3231; H04L 63/0815; G06K 9/00228; G06K 9/00288; G06T 7/10; G10L 17/08; G06K 7/1417; G10L 17/005

(57) ABSTRACT

A system for authenticating an access to a computerized records data-store by a plurality computer networking systems. The system includes a pre-stored identity information database to store identity information of the plurality of computer networking systems. The plurality of computer networking systems may include at least a first computer networking system and a second computer networking system such that the first computer networking system is uniquely defined by a first identity information and the second computer networking system is uniquely defined by a second identity information such that only the first computer networking system owns a registered digital account with the system and is authorized to access the computerized records data-store.

### CROSS-REFERENCE TO RELATED APPLICATIONS

This application is a continuation-in-part of U.S. patent application Ser. No. 13/756,433 filed on Jan. 31, 2013, which claims the benefit of U.S. Provisional Application No. 61/594,216, filed on Feb. 2, 2012, the complete disclosures of which, in their entireties, are hereby incorporated by reference.

### BACKGROUND

Technical Field

The embodiments herein generally relate to computer authentication, and more particularly to digital authentication in a connected computer network.

Description of the Related Art

Computer records may include a variety of information such as, in a medical setting, demographic information of patients, medical history, diagnostic and pathology reports, medical reports or prescriptions, or other such information. This information can be used for a variety of purposes by these sources of medical care. A few examples of them are, without limitations, tracking of the patients and their records, billing, historical assessments, integrating with medical devices, remote care, future care taking, telemedicine, proper ongoing medical or health assessment or treatment, or any other similar purpose.

One way to collate and store the medical data is with the use of an electronic health record data bank (EHRDB). These records from various entities can be electronically maintained such as by the electronic health record data bank (EHRDB) in a central system accessible by the entities. The EHRDB may store medical data of the entities and retrieve the data of the respective entities as and when requested by them. There is a need for an improved system and a method that provides a facility to interact with the EHRDB and also provide digital authentication mechanisms for a secured and private access.

### SUMMARY

An embodiment herein provides a blockchain configured distributed architecture-based system for authenticating an access to a computerized records data-store by a plurality of blockchain configured trusted computer networking systems located at remote locations within a blockchain configured computer network. The system includes a pre-stored identity information database to store identity information of the plurality of blockchain configured computer networking systems. The plurality of blockchain configured computer networking systems comprise at least a first computer networking system and a second computer networking system such that the first computer networking system is associated with a first entity and is uniquely defined by a first identity information and the second computer networking system is associated with a second entity and is uniquely defined by a second identity information, wherein only the first computer networking system owns a registered digital account with the system and is authorized to access the computerized records data-store. The system further includes a pre-stored digital community information database to store federated digital community information of the plurality of blockchain configured computer networking systems identifying whether the plurality of computer networking systems belong to the same federated digital community or different federated digital communities. The system includes an identity authorization device for verifying identity of the plurality of computer networking systems including verifying the first identity information and the second identity information. The identity authorization device includes a voice recognition device to detect voice inputs from the first entity associated with the first computer networking system and the second entity associated with the second computer networking system during access of the computerized records data-store respectively by the first networking system and the second computer networking system and compare the detected voice inputs with pre-stored voice patterns of the respective first identity information and the second identity information. The identity authorization device includes an image recognition device to detect face patterns of the first entity associated with the first computer networking system and the second entity associated with the second computer networking system during access of the computerized records data-store respectively by the first networking system and the second networking system and compare the detected face patterns with pre-stored face patterns of the first identity information and the second identity information. The system includes a processing circuit to authenticate the second computer networking system to access the computerized records data-store upon verification of the second identity information and if the second computer networking system and the first computer networking system belong to the same federated digital community of the computerized records data-store, even if the second computer networking system does not own a registered digital account with the system. The system includes a programmatic web interface comprising a single digital sign-on scheme to allow access of the computerized records data-store by the first computer networking system and the second computer networking system after verification of the first identity information and the second identity information respectively and upon verification that the second computer networking system and the first computer networking system belong to the same federated digital community of the computerized records data-store, wherein the processing circuit transforms the accessed computerized records into a digital data structure readable by a scanner.

The registered account with the system owned by the first computer networking system may be defined by a secured encrypted login credential information containing a unique digital identifier indicative of a registered access to the computerized records data-store. The login credential information associated with the first computer networking system of the first entity may be integrated within the first identity information so as the first identity information to also verify the login credential information of the registered account with the system. The blockchain configured computer network may comprise a first arbitrarily large number of blockchain configured computer networking systems of the plurality of blockchain configured computer networking systems and the federated digital community comprises a second arbitrarily large number of blockchain configured computer networking systems such that each such blockchain configured computer networking system of the second arbitrarily large number of blockchain configured computer networking systems is associated with a digitally stored computer executable profile indicative of a unique identity.

The digitally stored computer executable profile may be accessible through a unique social digital login credential of a computer networking system. The unique social digital login credential of a computer networking system together with an identity information of an associated entity may allow access to the computer records data-store upon verification by the identity authorization device, wherein the identity authorization device further comprising a social digital identity verification device such that the social digital identity verification device is configured to verify the social digital login credential of the computer networking system via the social networking server communicatively coupled to a third party network. The system may further comprise a set of computer executable rules configured to be executed by the processing circuit to associate one or more of the plurality of computer networking systems within a federated digital community.

The voice recognition device may comprise a communication interface that communicates with an external device; a hardware-based sound card including or coupled to an external microphone that collects sound to produce audio data; a voice recognition software to execute speech recognition instructions; and a microcontroller to analyze the audio data based on the speech recognition instructions and generate a signal indicative of the voice inputs. The image recognition device may comprise a communication interface that communicates with an external device; a hardware-based image acquisition device including a camera that collects an image from a live stream in the external device; an image segmentation device that breaks the image into a plurality of segmented portions; and a processor to analyze each of the segmented portions and generate a signal indicative of the face patterns.

Any of the first computer networking system, second computer networking system, identity authorization device, and scanner may comprise a mobile communication device. The digital data structure may comprise a QR (quick response) code. Any of the first computer networking system and the second computer networking system may comprise a cloud-based architecture. The processing circuit may transform the accessed computerized records into a multi-media format presented on a display device. The processing circuit may transform the accessed computerized records into an audio format output by a speaker.

### BRIEF DESCRIPTION OF THE DRAWINGS

The features of the disclosed embodiments may become apparent from the following detailed description taken in conjunction with the accompanying drawings showing illustrative embodiments, in which:

FIG. 1 illustrates generally, but not by the way of limitation, among other things, an example of a network communication system supporting a computer networking facility and a single sign-on scheme to access computerized records, in accordance with various embodiments;

FIG. 2 is a block diagram illustrating generally, but not by the way of limitation, among other things, an example of an operating environment in which various embodiments operate;

FIG. 3 illustrates generally, but not by the way of limitation, an example of a single sign-on authentication scheme that may be used to access the system such as those illustrated in FIG. 1 and FIG. 2, in accordance with an embodiment;

FIG. 4 illustrates a method of accessing a plurality of data sources using a single sign-on authentication scheme, in accordance with an embodiment;

FIG. 5 illustrates a system for authenticating an access to a computerized records data-store by a plurality of trusted computer networking facilities located at remote locations, in accordance with an embodiment;

FIG. 6 illustrates an embodiment of a voice recognition device contained within a digital information control device and communicatively coupled to a plurality of computer networking facilities, in accordance with an embodiment;

FIG. 7 illustrates an embodiment of an image recognition device contained within a digital information control device and communicatively coupled to a plurality of computer networking facilities, in accordance with an embodiment; and

FIG. 8 illustrates generally, but not by the way of limitation, a computer system that may be used in accordance with the embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, reference is made to the accompanying drawings that form a part hereof, and these are shown by way of illustrating specific embodiments herein that may be practiced. These embodiments, which are also referred to herein as “examples,” are described in sufficient detail to enable those skilled in the art to practice the embodiments herein, and it is to be understood that the embodiments may be combined, or that other embodiments may be utilized and that structural, logical, and electrical changes may be made without departing from the scope of the embodiments herein.

In this document, the terms “a” or “an” are used, as is common in patent documents, to include one or more than one. In this document, the term “or” is used to refer to a “nonexclusive or” unless otherwise indicated.

In an exemplary embodiment, the various modules described herein and illustrated in the figures are embodied as hardware-enabled modules and may be configured as a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that are configured with electronic circuits process computer logic instructions capable of providing digital and/or analog signals for performing various functions as described herein. The various functions can further be embodied and physically saved as any of data structures, data paths, data objects, data object models, object files, database components. For example, the data objects could be configured as a digital packet of structured data. The data structures could be configured as any of an array, tuple, map, union, variant, set, graph, tree, node, and an object, which may be stored and retrieved by computer memory and may be managed by processors, compilers, and other computer hardware components. The data paths can be configured as part of a computer CPU that performs operations and calculations as instructed by computer logic instructions. The data paths could include digital electronic circuits, multipliers, registers, and buses capable of performing data processing operations and arithmetic operations (e.g., Add, Subtract, etc.), bitwise logical operations (AND, OR, XOR, etc.), bit shift operations (e.g., arithmetic, logical, rotate, etc.), complex operations (e.g., using single clock calculations, sequential calculations, iterative calculations, etc.). The data objects may be configured as physical locations in computer memory and can be a variable, a data structure, or a function. In the embodiments configured as relational databases (e.g., such Oracle® relational databases), the data objects can be configured as a table or column. Other configuration; include specialized objects, distributed objects, object oriented programming objects,and semantic web objects, for example. The data object models can be configured as an application programming interface for creating HyperText Markup Language (HTML) and Extensible Markup Language (XML) electronic documents. The models can be further configured as any of a tree, graph, container, list, map, queue, set, stack, and variations thereof. The data object files are created by compilers and assemblers and contain generated binary code and data for a source file. The database components can include any of tables, indexes, views, stored procedures, and triggers.

A method or a system is provided for accessing computerized records via a single sign-on scheme provided by a computer networking facility. The computer networking facility allows access to the computerized records related to one or more users of a computerized records data-store. The method or the system comprises, receiving a request including a single sign-on credential via a single sign-on scheme facilitated by the computer networking facility. The single sign-on credential qualifies a qualification parameter stored in the computerized records data-store for accessing the computerized records associated with one or more users.

In general, various embodiments provide access to a computerized records access application, which further allows access to the computerized records data-store including the computerized records associated with the one or more users via the single sign-on scheme of the computer networking facility. The computerized records access application can implement one or more electronic security technologies providing the one or more users to view, manage, or control the computerized records related to different sources of the computerized records data-store via the single sign-on scheme of the computer networking facility. The detailed description about these sources is described in later paragraphs of the document.

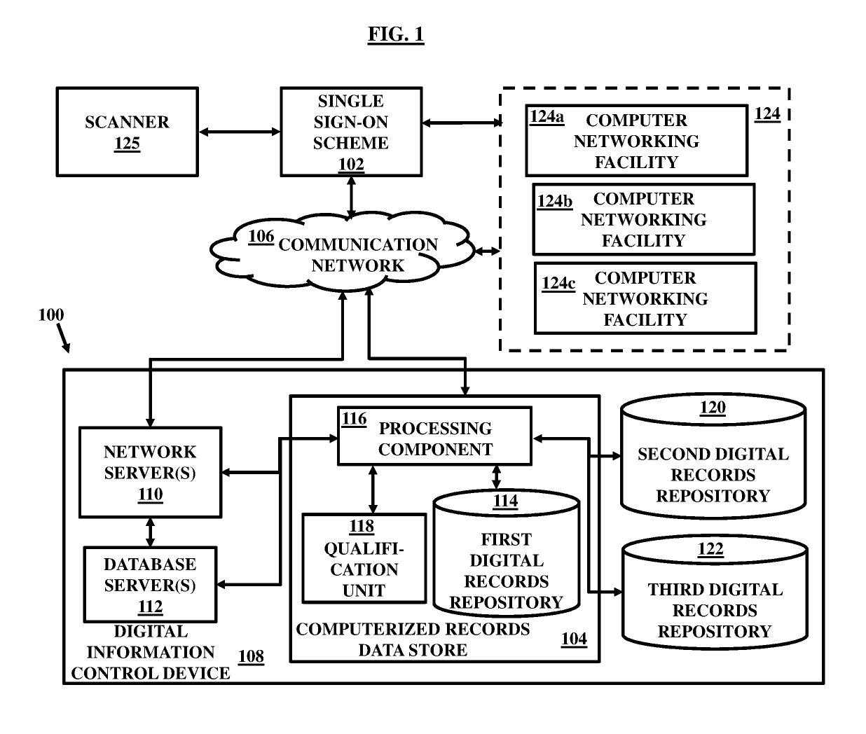

FIG. 1 illustrates generally, but not by the way of limitation, among other things, an example of a system 100 supporting one or more distinct computer networking facilities or systems 124a, 124b, 124c (together referred to as computer networking facility (or system) 124, which may be configured as cloud-based architectures) and a single sign-on scheme 102 to access a computerized records data-store 104 including computerized records (or digital records or simply records) associated with one or more users. The system 100 facilitates access to the computerized records data-store 104 through the computer networking facilities or platform 124 over a communications network 106. The system 100 allows the computer networking facilities 124 to provide the single sign-on scheme 102 to the one or more users for accessing the computerized records data-store 104. The single sign-on scheme 102 may be implemented, for example, as a software application running on a personal computer. The system 100 provides the single sign-on scheme 102 to the one or more users or entities. The one or more users described herein may be a web user executing instructions or tasks on a user machine such as a personal computer, laptop, portable device, mobile phone, tablets or any other machine. In examples, the web user described herein may be a web browser, or other types of web services that may be employed. The one or more users may be a patient, a doctor, a physician, a healthcare unit, a hospital, a nursing home, a healthcare professional or any other entity or a combination thereof. The one or more users may be referred to as the computer networking facilities 124 which are associated with the entities/users, in an embodiment.

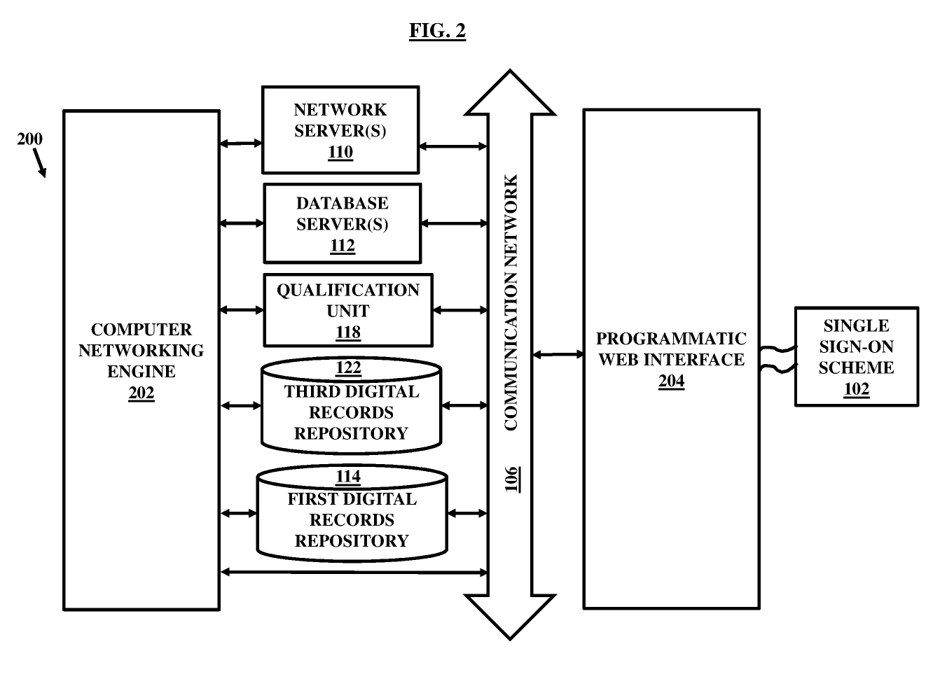

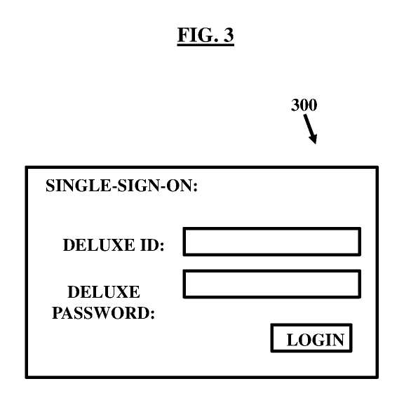

The system 100 provides or includes a digital information control device 108, which implements information storage and retrieval functions and services for the one or more entities accessing the digital information control device 108 or the computerized records data-store 104. The digital information control device 108 includes a network server 110 to provide a programmatic web interface (shown in FIG. 2). The programmatic web interface may be configured as the single sign-on scheme 102 to allow access of the computerized records data-store 104 or one or more portions of the computerized records data-store 104. In an embodiment, the programmatic web interface is configured as the single sign-on scheme 102 to allow access of the one or more portions of the computerized records data-store 104 from one or more distinct computer networking facilities 124 using a credential associated with any of the one or more of the distinct computer networking facilities 124. The programmatic web interface facilitates the one or more entities to provide the single sign-on access to the computerized records data-store 104. The digital information control device 108 may further include or is coupled to one or more database servers 112. The network server 110 is shown to be coupled to the one or more database servers 112 that facilitate access to digital data associated with one or more users in the communication network 106. The computerized records data-store 104 may be communicatively coupled to or integrated within the digital information control device 108. The single sign-on scheme transforms the accessed computerized records into a digital data structure (e.g., QR (quick response) code, etc.) readable by a scanner 125 such that the scanner 125 may be configured as a mobile device that has an app for reading QR codes. The readable QR code, when read by the scanner 125, transforms the data structure into a multi-media format by presenting and displaying the accessed data onto a display device (e.g., such as on a mobile device, or on the programmatic web interface 204 of FIG. 2, or display 1023 of FIG. 9, etc.). Audio components of the multi-media format may be output through a speaker (e.g., on the mobile device, or connected to the programmatic web interface 204 of FIG. 2, or speaker 1024 of FIG. 9, etc.).

In an embodiment, the computer networking facilities 124 may manage a plurality of social networking or any other networking services utilizing a digitally secured access scheme for authentication and identity validation purposes. In an example, the computer networking facilities 124 may be a social networking platform or may be associated with a social networking platform.

The computerized records data-store 104, described herein, may be centralized or decentralized. The computerized records data-store 104 may store the computerized records related to the one or more entities (also referred as users) in a first digital records repository 114. The one or more users may be associated with respective one or more computing devices for interacting with the computerized records data-store 104 and various other systems and sub-systems thereof. The computerized records data-store 104 may communicate with different servers and repositories such as the network server 110, the database server 112, a second digital records repository 120, a third digital records repository 122 or any other server or repository to form a social cloud among the one or more users. The first digital records repository 114 can store a plurality of computerized records including data or information related to the one or more users. The data can be organized in a way that facilitates local or remote information retrieval in the communication network 106 via a processing component 116. In some embodiments, the processing component 116 may comprise, but is not limited to, a microprocessor, a microcontroller, or equivalent. The processing component 116 may be capable of executing instructions to process data over the communications network 106. The data corresponding to an individual user may or may not have been derived from medical testing or treatment (e.g., the data may have been derived from a research organization trial in which the individual voluntarily participated or data may have been derived from insurance services or any other source).

More generally, the computerized records data-store 104 may also include data related to different sources such as doctor's visits, lab tests, hospital stays, clinical trials, patient problems, patients health information, patient habits, patient medical history, patient appointments, patient medical insurance, patient medical bills status, or any other information. The computerized records data-store 104 may be coupled to other data sources such as the second digital records repository 120 and the third digital records repository 122. The second digital records repository 120 may include electronic information related to a region, community, or a medical ecosystem. The second digital records repository 120 may exchange the digital information among other digital information exchange systems such that the second digital information repository 120 may allow safe access to the digital information by one or more users via the computerized records data-store 104 and systems thereof such as the first digital records repository 114, the second digital records repository 120, and the third digital records repository 122. The third digital records repository 122 may store virtual digital records related to the digital information associated with the one or more users. The virtual digital records described herein may be simplified, standardized digital records designed to support interfacing to the computerized records data-store 104 such that the present system 100 can allow the one or more users to access the digital data from different sources such as the computerized records data-store 104, the second digital records repository 120, the third digital records repository 122, or any other sources via the single sign-on scheme 102.

In some embodiments, the programmatic web interface as discussed above may be configured as the single sign-on scheme 102 to allow access of the one or more of the first digital records repository 114, second digital records repository 120, and the third digital records repository 122 of the computerized records data-store 104 from one or more distinct computer networking facilities 124 using a credential associated with any of the one or more of the distinct computer networking facilities 124. The one or more of the first digital records repository 114, second digital records repository 120, and the third digital records repository 122 may each be provided with a distinct application configured to be initiated upon access of the respective of the first digital records repository 114, second digital records repository 120, and the third digital records repository 122 allowing retrieval of the digital records associated with the first digital records repository 114, second digital records repository 120, and the third digital records repository 122.

In some embodiments, the single sign-on scheme 102 provides a single authentication mechanism across various data repositories and systems as discussed above instead on one single system or repository. Generally, the digital records may be stored in more than one systems or repositories. The digital records (interchangeably referred to as computerized records without limitations) may be federated across the various repositories. Therefore, the single sign-on scheme 102 provides a federated social authentication mechanism.

The computerized records data-store 104 may include or be coupled to a qualification unit 118. The qualification unit 118 is capable of storing the one or more users' credential such as a username, password, or other data. The qualification unit 118 may also store one or more policies or rules associated with the one or more users, which may restrict access to portions of the digital records access application or other sources. The computerized records data-store 104 allows the network server 110 and database server 112 to interact with the qualification unit 118 to provide access to the computerized records related to the one or more users. The qualification unit 118 provides the one or more users qualification testing techniques or applications, which are used to identify the one or more users to access the computerized records data-store 104 in a computer network such that a social cloud may be organized among the one or more users. The computerized records data-store 104 may also interact with the database server 112 and first digital records repository 114 to store and retrieve data related thereto. The qualification unit 118 may operate on information received from the single sign-on scheme 102 of the computer networking facility such as 124a. The computer networking facility 124a described herein may be, but is not limited to, Facebook™, Twitter™, LinkedIn™, Orkut™ or any other computer networking facility or computing system capable of providing a networking facility, in an embodiment. Alternatively, the qualification unit 118 may also operate on information received from the computerized records access application allowing access to the computerized records data-store 104. The qualification unit 118 may authenticate the access to the computerized records data-store 104 based on the general username and the password and access levels associated with the roles of the one or more users via the computerized records access application. In examples, the information received from the computerized records access application may be for example, but not limited to, general user credentials such as a username and password combination, user Google™ ID and password combination, user Amazon™ ID and password combination, or the like.

In some embodiments, the computerized records data-store 104 may also be referred to as an Electronic Records Database (ERDB).

In accordance with some embodiments, authentication may be enabled through a fast and automated authentication scheme in which mobile phone numbers, IP addresses or any other specific details for the one or more users that may be pre-stored with the computerized records data-store 104 may be compared with the details of the one or more users during access. Then, upon comparison and confirmation, authentication may be performed accordingly. For example, if the mobile phone number used for accessing the computerized records data-store 104 is matched with the pre-stored number, the user may be automatically allowed to access the computerized records data-store 104 and without necessarily providing the details for confirmation again.

In an embodiment, the term single sign-on scheme 102 herein means that a user provides a single unique identifier (ID) and password combination (also referred to as credential information or login details or login credential) to gain access to one or multiple sources of the computerized records data-store 104 over the communication network 106 such as the Internet. In an embodiment, the term single sign-on scheme 102 is defined such that a user may provide any of several unique identifiers (IDs) and password combinations associated with several distinct computer networking facilities 124 respectively to gain access to one or multiple services of the computerized records data-store 104.

In an example, the single sign-on scheme 102 corresponding to a user may include a first credential associated with a first computer networking facility 124a, a second credential associated with a second computer networking facility 124b, and a third credential associated with a third computer networking facility 124c such that the user is associated with each of the first, second, and third computer networking facilities or platforms 124a, 124b, and 124c. The user is allowed to access the one or more of the first digital records repository 114, second digital records repository 120, the third digital records repository 122 using any one of the first credential, second credential, and third credential from any of the first computer networking facility, second computer networking facility, and the third computer networking facility 124a, 124b, and 124c. In an example, the single sign-on scheme 102 corresponding to a user is defined to associate a plurality of repositories of the computerized records data-store 104 with a plurality of computer networking facilities 124 associated with the user such that the single sign-on scheme 102 includes a first credential associated with a first computer networking facility 124a of the user, a second credential associated with a second computer networking facility 124b of the user, and a third credential associated with a third computer networking facility 124c of the user. The user is allowed to access the first digital records repository 114 using the first credential from the first computer networking facility 124a, second digital records repository 120 using the second credential from the second computer networking facility 124b, and the third digital records repository 122 using the third credential from the third computer networking facility 124c.

In an example, the single sign-on scheme 102 corresponding to a user is defined to associate a plurality of repositories of the computerized records data-store 104 with a plurality of computer networking facilities 124 associated with the user such that the single sign-on scheme 102 includes a first credential associated with a first computer networking facility 124a of the user, a second credential associated with a second computer networking facility 124b of the user, and a third credential associated with a third computer networking facility 124c of the user. The user may be allowed to access the first digital records repository 114 using the first credential from any of the first, second and third computer networking facility 124, second digital records repository 120 using the second credential from any of the first, second, and third computer networking facility 124, and the third digital records repository 122 using the third credential from any of the first, second, and third computer networking facility 124.

In an example, the single sign-on scheme 102 corresponding to a user is defined to associate a plurality of repositories of the computerized records data-store 104 with a plurality of computer networking facilities 124 associated with the user such that the single sign-on scheme 102 includes a first credential associated with a first computer networking facility 124a of the user, a second credential associated with a second computer networking facility 124b of the user, and a third credential associated with a third computer networking facility 124c of the user. The user is allowed to access the first digital records repository 114 using the first, or second, or third credential from the first computer networking facility 124a, second digital records repository 120 using any of the first, second and third credential from the second computer networking facility 124b, and the third digital records repository 122 using any of the first, second, and third credential from the third computer networking facility 124c.

In an example, the single sign-on scheme 102 corresponding to a user is defined to associate a plurality of repositories of the computerized records data-store 104 with a plurality of computer networking facilities 124 associated with the user. The plurality of repositories includes the first digital records repository 114, second digital records repository 120, and the third digital records repository 122 and the like which are configured as virtual partitions, in an embodiment, within the computerized records data-store 104 such that the single sign-on credential associated with the user is mapped by the network server 110 or the digital information control device 108 to allow access to the respective virtual partitions of the computerized records data-store 104. In an example, the single sign-on scheme 102 corresponding to the user may include a first credential associated with a first computer networking facility 124a, a second credential associated with a second computer networking facility 124b, and a third credential associated with a third computer networking facility 124c such that the user is allowed to access the one or more of the virtual partitions-based repositories using one of the first credential, second credential, and third credential from any of the first computer networking facility 124a, second networking facility 124b, and the third networking facility 124c or directly from a dedicated interface corresponding to the one or more virtual partitions. The dedicated interface may be any interface that supports specific portions of the computerized records data-store 104. In an example, a virtual layer may be deployed to allocate storage resources across the virtual partitions of the plurality of repositories for storage of the computerized records corresponding to the user.

In an example, the single sign-on scheme 102 is configured as a multi-domain single sign-on scheme such that a user credential associated with any of a plurality of distinct-web-domain-based computer networking facilities such as 124a and 124b enables access to the computerized records data-store 104.

In an example, the computer networking facility such as 124a may include a web interface including a tab such that the single sign-on scheme 102 may be triggered by activating an application through the tab manually. For example, the user when presses the tab may activate the application causing access to the computerized records data-store 104 or any of its portions through the single sign-on scheme 102. In another embodiment, the computer networking facility 124a may include a web interface without any physical tab such that the single sign-on scheme 102 may be triggered automatically to activate an application as soon as the computer networking facility 124a is accessed by the user.

It must be appreciated that the terms “computer networking system” and “computer networking facility” are used interchangeably without any limitations. In some embodiments, the computer networking facility may be defined as any networking arrangement such as social networking platform or a web-interface configured to allow network connections, or any standalone system or computational device configured to allow networking capability.

FIG. 2, with reference to FIG. 1, is a block diagram that illustrates generally, but not by the way of limitation, among other things, an example of an operating environment 200 in which various embodiments operate. The environment 200 includes a computer networking engine 202, which may be controlled by the network server 110 to process the one or more user's data or request. The computer networking engine 202 is communicatively coupled to the computerized records data-store 104 through the network server 110 to allow interfacing of the computerized records data-store 104 with the computer networking facility or platform 124. The network server 110 may provide a programmatic web interface 204 to the one or more users via the communication network 106. In examples, the programmatic web interface 204 is a single sign-on interface displayed to the one or more users to access the computerized records data-store 104 as shown in FIG. 3. The database server 112 may maintain digital data related to the one or more users and integrate the digital data with the network server 110. The database server 112 may also store digital information related to an authenticated user and associated application to provide access to the computerized records data-store 104. The database server 112 may provide access to the stored applications based on the single sign-on credential provided by the user via the single sign-on scheme 102. In an example, the application described herein may be the computerized records access application.

The qualification unit 118 further maintains qualification parameters associated with the one or more users of the computerized records data-store 104. The qualification parameters may include the user credential information to access the computerized records access application via the single sign-on scheme 102 of the computer networking facility 124 such that the one or more users can access, manage, or control the computerized information associated with various sources such as the computerized records data-store 104, the second digital records repository 120, the third digital records repository 122, or any other sources via the single sign-on scheme 102. The qualification parameters may also include one or more users' role and policy information that may be used by the qualification unit 118 to qualify the one or more users to access the computerized records data-store 104. In examples, the qualification unit 118 may interact with the computer networking engine 202 to automatically test the credential provided by the single sign-on scheme 102, in accordance with the stored qualification parameters by the qualification unit 118, such that the user can access the computerized records data-store 104 via the computer networking facility 124. The access to the computerized records data-store 104 by the computer networking engine 202 may be controlled by the qualification unit 118. The qualification unit 118 may use stored policies and rules to provide user specific access to the computerized records via the computer networking facility 124.

In examples, the qualification unit 118 may provide an access control mechanism for qualifying the one or more users to access the computerized records data-store 104. The access control mechanism may allow the qualification unit 118 to send a request to the computerized records data-store 104 to allow the one or more users to access the computerized records associated with various sources such as the computerized records data-store 104, the second digital records repository 120, the third digital records repository 122, or any other sources, in accordance with the qualifying parameters and single sign-on credential received by the single sign-on scheme 202 of the computer networking facility 124. As a result, a user qualified by the qualification unit 118 may be allowed to access the computerized records data-store 104 and associated computerized records of the one or more users. The qualification unit 118 may then allow the computer networking engine 202 to interact with the first digital records repository 114, second digital records 122, or the third digital records repository 120 to provide access of the computerized records to the one or more qualified users. The qualification unit 118 may develop additional Application Programming Interfaces (APIs), which may allow batch uploading of data for qualification processing associated with the one or more users.

FIG. 3, with reference to FIGS. 1 and 2, illustrates generally, but not by the way of limitation, an example of the single sign-on scheme 102 that may be used to access the system 100 such as illustrated in FIG. 1 and FIG. 2. The one or more users may log into the system 100 by supplying the single sign-on credential such as deluxe unique identifier (ID) and deluxe password. The term deluxe described herein means that the user provides a single unique ID and password combination to the single sign-on scheme 102 to gain access to one or multiple sources of the computerized records data-store 104, the second digital records repository 120, the third digital records repository 122, or any other source via the computer networking facility 124 over the communication network 106. Once the user is logged into system 100, the single sign-on scheme 102 may present the one or more users with the computerized records associated with the one or more users to access the computerized records data-store 104, in accordance with the single sign-on credential associated with the one or more users. For example, the single sign-on scheme 102 may present a computerized records access application allowing access to the computerized records associated with the one or more users. The computerized records access application may be customized to provide access to different portions of the one or multiple sources associated with the one or more users that can be automatically accessed using the deluxe password and unique ID stored within system 100.

A method may also be provided for using the system 100 to access the computerized records data-store 104, in accordance with some embodiments. The method may allow the one or more users to provide the single sign-on credential to use the computerized records data-store 104 via the computer networking facility 124.

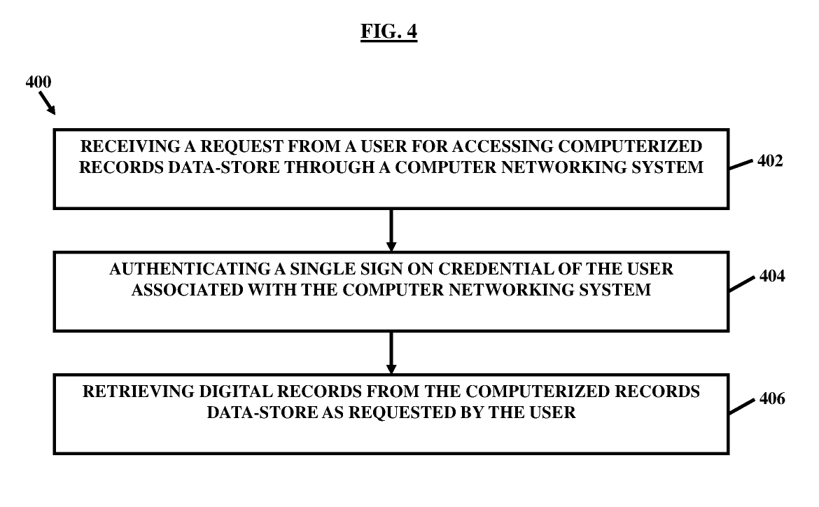

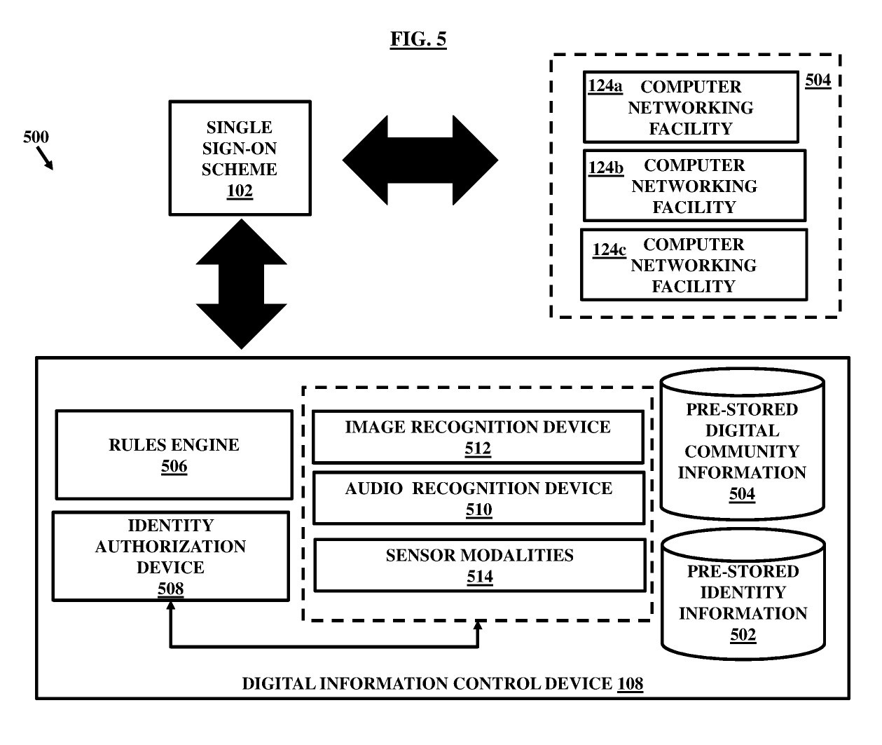

FIG. 4, with reference to FIGS. 1 through 3, illustrates a method of accessing a plurality of data sources associated with the computerized records data-store 104 using a single sign-on authentication scheme. The single sign-on scheme can be any of the single sign-on schemes 102 as discussed above in the form of various examples and embodiments.

At step 402, the method includes receiving a request from a user for accessing the computerized records data-store 104 through the computer networking facility 124. The method further includes authenticating a single sign-on credential of the user associated with the computer networking facility 124 at step 404. The credential associated for single sign-on has been discussed above in the form of several examples and embodiments. The method further includes retrieving medical records from the computerized records data-store 104 or one or more portions of the computerized records data-store 104 as requested by the user at step 406. The method of retrieving of the digital records may include at least one of sharing of the digital records either partially or fully to the user and allowing viewing of the digital records at least partially by the user. In an embodiment, the computer networking facility 124 is a first computer networking system such as 124a, and the credential is a first credential associated with the first computer networking facility 124a. The method may further include receiving a second request from the user for accessing the computerized records data-store 104 using a second credential through a second computer networking facility 124b. In an embodiment, at least one combination of (1) the first credential and the second credential (2) the first computer networking system 124a and the second computer networking system 124b, is different. For example, in case of (1), the user may access the portions of the computerized records data-store 104 using different credentials through the single sign-on scheme 102. In case of (2), the user may access various portions of the computerized records data-store 104 using various distinct computer networking facilities such as 124a and 124b with the use of the single sign-on feature 102. In an embodiment, the single sign-on scheme 102 allows access of the computerized records data-store 104 by the user automatically upon accessing either of the first computer networking facility 124a using the first credential or the second computer networking facility 124b using the second credential.

FIG. 5 illustrates a system 500 for authenticating an access to the computerized records data-store 104 by the plurality of trusted computer networking facilities located at remote locations, in an embodiment of the present invention. In accordance with the embodiments described herein in conjunction with FIG. 5, the computer networking facility may be similar to the computer networking facility 124 discussed in conjunctions with FIGS. 1-4. In an example, the embodiments described herein in conjunction with FIG. 5, the computer networking facility 124 may include a computing system configured to access the computer networking facility of FIGS. 1-4.

The system 400 may include the digital information control device 108 coupled communicatively with the plurality of computer networking facilities 124. The system 400 includes a qualification unit similar to the qualification unit 118 discussed earlier. The qualification unit 118 described in conjunction with the embodiment of FIG. 5 may further include a pre-stored identity information database 502 to store identity information of the plurality of computer networking facilities 124. The qualification unit 118 may further include a pre-stored digital community information database 504 to store federated digital community information about the plurality of computer networking facilities 124. The federated digital community information is discussed hereafter.

In an embodiment, each of the computer networking facilities 124 may be associated with respective entities or users. An entity may be defined as any user of a computer networking facility 124 such as a patient, healthcare provider, care taker, or any other user in general. In accordance with embodiments discussed herein, one or more entities may be associated with one another through a community such that the community may identity a digitally identifiable association through the respective computer networking facilities 124, in an embodiment. For example, one or more physicians may be associated with a patient, a financial agency may be associated with the same patient, and a group of care takers may further be associated with the same patient in a manner that all these entities may together form a group toward delivering certain healthcare services for the patient. These entities may form a community that may be identifiable uniquely in a digital manner and may be associated with one another through unique community identifiers in association with individual entity identifiers. Since these entities may be located at distant locations and may communicate through respective computer networking facilities 124 with one another through digital ways, they form a respective federated community identifiable by the system 500 through a digital community identifier associated with the community and individual entity identifiers (or individual computer networking facility identifiers or simply facility identifiers) for entities that form parts of the federated community. The community identifiers and the facility identifiers belonging as elements to the federated community may be stored in the pre-stored identity information database 502 as respective identity information of the federated community as well as the computer networking facilities 124 belonging to the federated community.

In the embodiment shown in FIG. 5, the computer networking facility 124a and 124b form part of the same federated community and the 124c does not form part of the same federated community. Each of the computer networking facilities may be associated with individual facility identifiers. The computer networking facility 124a and the computer networking facility 124b may be associated with a unique federated digital community identifier and the 124c may be associated with a unique community identifier which is different from the community identifier to which the computer networking facility 124a and 124b belongs to. These respective facility identifiers and the federated digital community identifiers may be stored in the identity information database 502. In an embodiment, new elements or facilities or entities may join in any of the federated communities or existing elements may drop out thereby dynamically changing characteristics of the federated digital community with time. Also, a federated digital community may define its own rules to add, change, and remove elements from the federated digital community which may be stored in a rules engine 506. In an embodiment, the rules engine may be contained within the qualification unit 118 or may be deployed as a separate device.

In accordance with an embodiment, not all computer networking facilities 124 and/or associated entities may be registered with the digital information control device 108 and manage respective digital accounts of the digital information control device 108 such that the respective digital accounts are identified through their respective unique registration information of the computer networking facilities 124 and/or their associated entities. The registration of the computer networking facilities 124 or the entities with the digital information control device 108 may allow them to access the computerized records data store 104 and its associated repositories based on access privileges as verified by the qualification unit 118 and other components discussed in conjunction with various figures earlier.

In an example, the first computer networking facility 124a may be registered with the digital information control device 108 through its registration information. The second computer networking facility 124b is not registered with the information control device 108. The third computer networking facility 124c is also registered with the information control device 108.

The pre-stored identity information database 502 may store an identity information of the first computer networking facility 124a, an identity information of the second computer networking facility 124b, an identity information of the third community networking facility 124c as a digital identifier of the first computer networking facility 124a, a digital identifier of the second computer networking facility 124b, and a digital identifier of the third computer networking facility 124c.

The pre-stored digital community information database 502 may store federated digital community information of a first community to which the first computer networking facility 124a and the second computer networking facility 124b belong to and federated digital community information of a second community to which the third computer networking facility 124c belongs to. The information about the first community and the second community stored in the pre-stored digital community information database 504 can identify whether the plurality of computer networking facilities 124 belong to same federated digital community or different federated digital communities.

The system 500 may include an identity authorization device 508 for verifying identity of the plurality of computer networking facilities 124. The identity authorization device 508 includes a voice or audio recognition device 510, an image recognition device 512, and sensor modalities 514 which are discussed later in the document.

The information control device 108 may include the processing component 116 to authenticate the plurality of computer networking facilities 124 and allow access to the computerized records data-store 114 and its associated repositories based on access privileges upon verification of their respective identity information by the identity authorization device 508. In accordance with the embodiment discussed herein, the processing component 116 may authenticate the first computer networking facility 124a to access the computerized records data-store upon verification of its identity information along with its registration information by the identity authorization device 508 because the first computer networking facility 124a is registered with the information control device 108. In an embodiment, the registration information may be identified through the identification information of the first computer networking facility so that separate registration information may need not to be verified. In an embodiment, however, the registration information may be defined separately and may need to be verified separately in order to gain access to the computerized records data-store 114.

In accordance with the embodiment discussed herein, the processing component 116 may authenticate the second computer networking system 124b to access the computerized records data-store 114 upon verification of its identity information but even without verifying for its registration information by the identity authorization device 508. The processing component 116 authenticates the second computer networking facility 124b to access the computerized records data-store 114 upon verification of its identity information if the second computer networking facility 124b and the first computer networking facility 124a belong to the same federated digital community of the computerized records data-store 114, even if the second computer networking facility 124b does not own its own registered digital account with the digital information control device 108. However, the processing component 116 may verify that the first computer networking facility 124a and the second computer networking facility 124b belong to the same federated digital community from the information contained in the pre-stored digital community information database 504.

The system 500 may include the programmatic web interface configured as the single digital sign-on scheme 102 to allow access of the computerized records data-store 114 by the first computer networking facility 124a and the second computer networking facility 124b after verification of the respective identity information and upon verification that the second computer networking facility 124b and the first computer networking facility 124a belong to the same federated digital community of the computerized records data-store 114. The programmatic web interface has been discussed in conjunction with various figured above. The single digital sign on scheme 102 in accordance with the embodiment illustrated in FIG. 5 allows the second computer networking facility 124b and the first computer networking facility 124a to access the computerized records data-store 114 by using their respective identity information belonging to the same federated digital community without having a need to get separate registration information.

However, the processing component 116 may now allow the third computer networking facility 124c to access the computerized records data-store 114 merely by verification of its identity information unless the third computer networking facility 124c belong to the second community which contains at least one element registered with the information control device 108. The third computer networking facility 124c however may access the computerized records data-store 114 upon verification of its identity information and its registration information.

In an embodiment, the federated digital community may be defined by a trusted computerized group of digitally stored computer executable profiles associated with a networking server such that each such digitally stored computer executable profile is associated with one of the plurality of computer networking facilities 124 and an associated entity who is uniquely identifiable by its identity information. In an example, the networking server may be a social networking server so that a social networking profile may represent an associated entity and respective computer networking facilities 124. In such cases, multiple social profiles may form a community based on certain criteria which may be defined by the entities of the community or may be dynamically determined by the information control device 108 such as based on who a patient is and which all entities are associated with the patient at a particular time for providing health services and care taking of the patient etc. Each such digitally executable social profile of an entity may be identified by its identity information which may be indicated through social login credentials in an example.

The registered account of the first computer networking facility 124a and the third computer networking facility 124c associated with the system 500 and owned by the first computer networking facility 124a and the third computer networking facility 124c respectively may be defined by secured encrypted login credential information containing unique digital identifiers indicative of registered access to the computerized records data-store 114. In some embodiments, the login credential information associated with the first computer networking facility 124a and the third computer networking facility 124c of the first entity and the third entity respectively may be integrated within their respective identity information so as the identity information can verify the login credential information of their registered accounts with the system.

In some embodiments, the social networking server may be defined by a first arbitrarily large number of computer networking facilities of the plurality of computer networking facilities 124 so that some of the computer networking facilities identified through their computer executable social profiles may form part of one or more federated digital communities. These federated digital communities may also include an arbitrarily large number of computer networking systems (which is a subset of the first arbitrarily large number of computer networking facilities) such that each such computer networking facility is associated with a digitally stored computer executable profile indicative of a unique identity. In an embodiment, this digital identity is defined by a respective social profile accessible through a social login such that each social networking facility or entity belonging to a particular federated digital community may access the computerized records data-store 114 by using its social login even if it is not registered with the information control device but at least one of the computer networking facilities belonging to the same federated digital community is registered with the information control device. The digitally stored computer executable profiles associated with the arbitrarily large number of computer networking facilities or associated entities defined by the respective social profiles are accessible through their respective unique social digital login credentials. The unique social digital login credentials of the arbitrarily large number of computer networking facilities together with the respective identity information of the associated entities allow access to the computerized records data-store upon verification by the identity authorization device 508. The identity authorization device 508 in such embodiments may include a social digital identity verification device such that the social digital identity verification device is configured to verify the social digital login credentials of the computer networking systems such as 124 via the social networking server which may be communicatively coupled to a third party network. The processing component 116 may execute a set of computer executable rules to associate one or more of the plurality of computer networking systems 124 within a particular federated digital community.

The single sign on scheme 102 may be enabled to facilitate access by multiple computer networking facilities 124a and 124b belonging to the same federated digital community to access the computerized records data-store even without all of them being registered with the system. The single sign on scheme 102 has been discussed above.

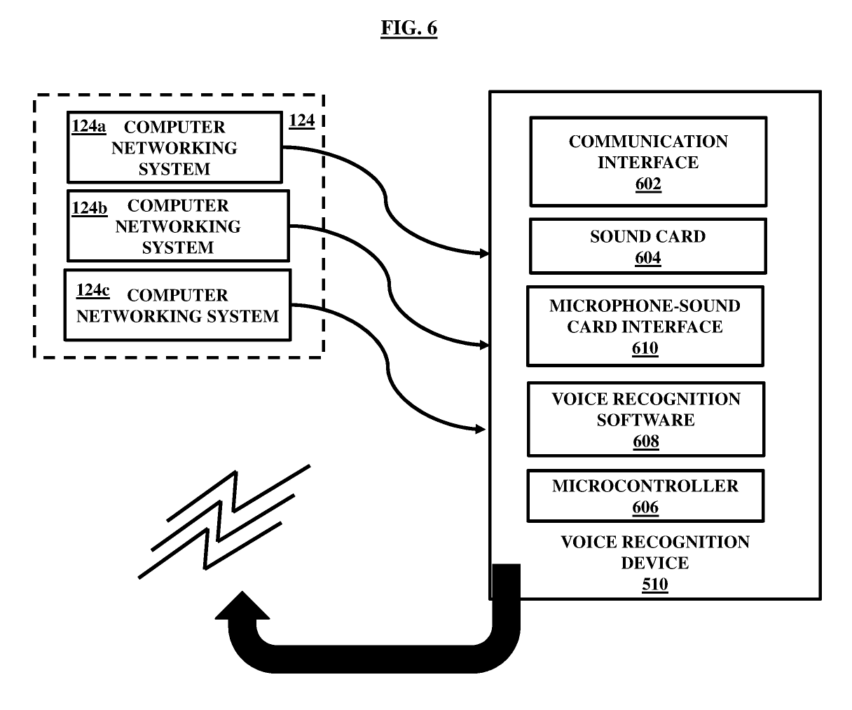

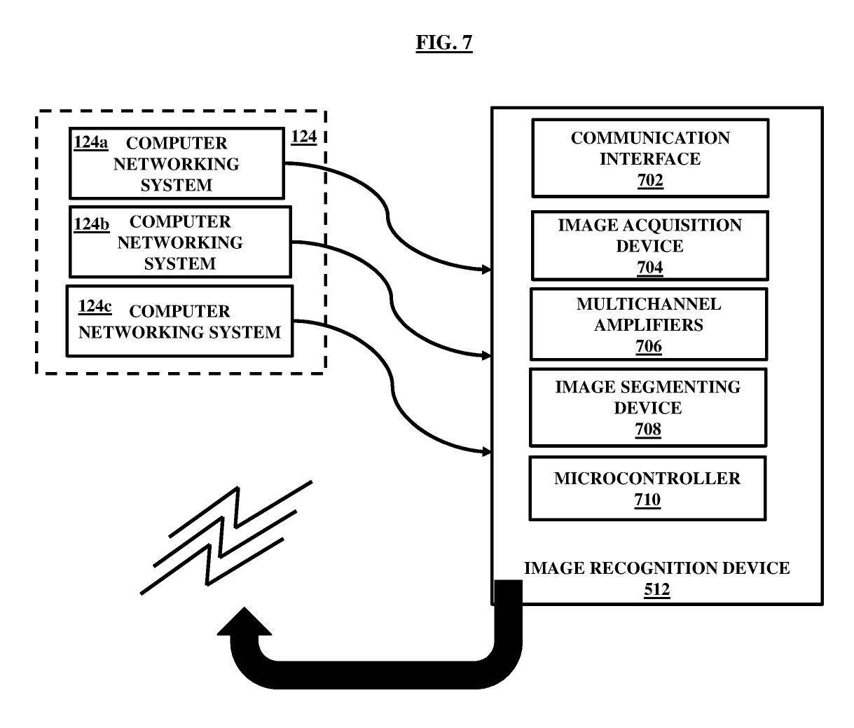

FIG. 6 illustrates an embodiment of the voice recognition device (or audio recognition device) 510 contained within the digital information control device 108 and communicatively coupled to the plurality of computer networking facilities 124 including the first computer networking facility 124a, the second computer networking facility 124b, and the third computer networking facility 124c. The voice recognition device 510 and the entire digital information control device 108 that contains the voice recognition device 510 may be coupled to the computer networking facilities 124 via the single sign on scheme 102 for enabling access upon authorization by the authorization device 508. In this embodiment, the identification and authorization of identity of the entities and/or the associated computer networking systems 124 may be established based on voice patterns of the respective entities.

The voice recognition device 510 includes a communication interface 602 for establishing communication with the single sign on scheme 102 over the communication network 106. The voice recognition device 510 further includes a sound card 604. The sound card 604 is adapted to receive identity information of a respective entity associated with a computer networking system such as 124a. The identity information is received in the form of a digital audio signal. The sound card 604 is adapted to receive the digital audio signal and generate/transmit the audio signal to a microcontroller 606 for voice recognition based on pre-stored voice patterns. The sound card 604 is adapted to sample an analog signal to generate the digital audio signal and interface with the microcontroller 606. The microcontroller 606, in association with the voice recognition software 608, is adapted to discriminate between multiple audio patterns and also compare the voice pattern of the entity with the pre-stored voice patterns to output a stream signal. The stream signal is indicative of verification of the identity information. If the identity is verified, the entity and the associated computer networking facility such as 124a may be authorized for further transactions as discussed above. In an embodiment, the voice recognition device 510 may include a microphone-sound card interface 610 for allowing interfacing between an external microphone with the sound card 604 of the voice recognition device 510.

FIG. 7 illustrates an embodiment of the image recognition device 512 contained within the digital information control device 108 and communicatively coupled to the plurality of computer networking facilities 124 including the first computer networking facility 124a, the second computer networking facility 124b, and the third computer networking facility 124c. The image recognition device 512 and the entire digital information control device 108 that contains the image recognition device 512 may be coupled to the computer networking facilities 124 via the single sign on scheme 102 for enabling access upon authorization by the authorization device 508. In this embodiment, identification and authorization of the identity of the entities and/or associated computer networking systems 124 may be established based on image patterns of the respective entities.

The image recognition device 512 includes a communication interface 702 for establishing communication with the single sign on scheme 102 over the communication network 106 similar to the communication interface 602 of FIG. 6. The image recognition device 512 includes an image acquisition device 704 to receive signals containing image patterns and facial expressions. The image acquisition device 704 may include or be coupled to an external camera for taking still or streaming images. The image acquisition device 704 may include a plurality of multichannel amplifiers 706 such that each amplifier of the multichannel amplifiers 706 may be defined to receive a specific type of sensed information from a particular type of sensor or camera sourcing signals for the image recognition device 512. The amplified signals obtained from the plurality of multichannel amplifiers 706 are then transmitted to the image segmentation device 708 for fragmenting the received image patterns to identify micro level details such as micro facial expressions and the like. These federated image patterns are then transmitted to the microcontroller 710 or further processing and verification of the identity of the entity. The identity information is received in the form of a digital audio signal containing the received image patterns. The image acquisition device 704 is adapted to receive the digital audio signal and generate/transmit the audio signal to the microcontroller 710 for image recognition based on pre-stored image patterns (including such as micro facial expressions). The image recognition device 512 is adapted to sample an analog signal to generate the digital audio signal and interface with the microcontroller 710. The microcontroller, in association with the necessary recognition software, is adapted to discriminate between multiple image patterns and also compare the image pattern of the entity with the pre-stored image patterns to output a stream signal. The stream signal is indicative of verification of the identity information as obtained in the form of the image pattern. If the identity is verified, the entity and the associated computer networking facility such as 124a may be authorized for further transactions as discussed above.

In some embodiment, various sensor modalities 514 may be contained within the digital information control device 108 and communicatively coupled to the plurality of computer networking facilities 124 including the first computer networking facility 124a, the second computer networking facility 124b, and the third computer networking facility 124c. The sensor modalities 514 and the entire digital information control device 108 that contains the sensor modalities 514 may be coupled to the computer networking facilities 124 via the single sign on scheme 102 for enabling access upon authorization by the authorization device 508. In this embodiment, identification and authorization of the identity of the entities and/or associated computer networking systems 124 may be established based on sensed contextual patterns of the respective entities by external sensors such as but not limited to a Global Positioning System (GPS)-based device, weather sensors, location sensors, and the like, and verifying the sensed contextual patterns against pre-stored patterns associated with entities and their computer networking facilities 124.

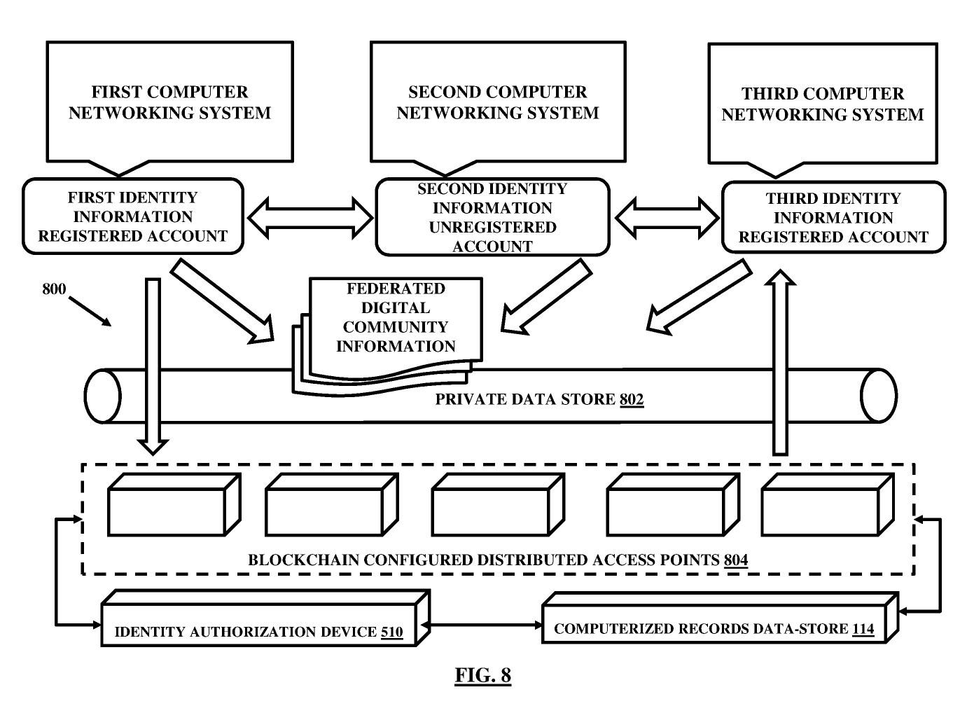

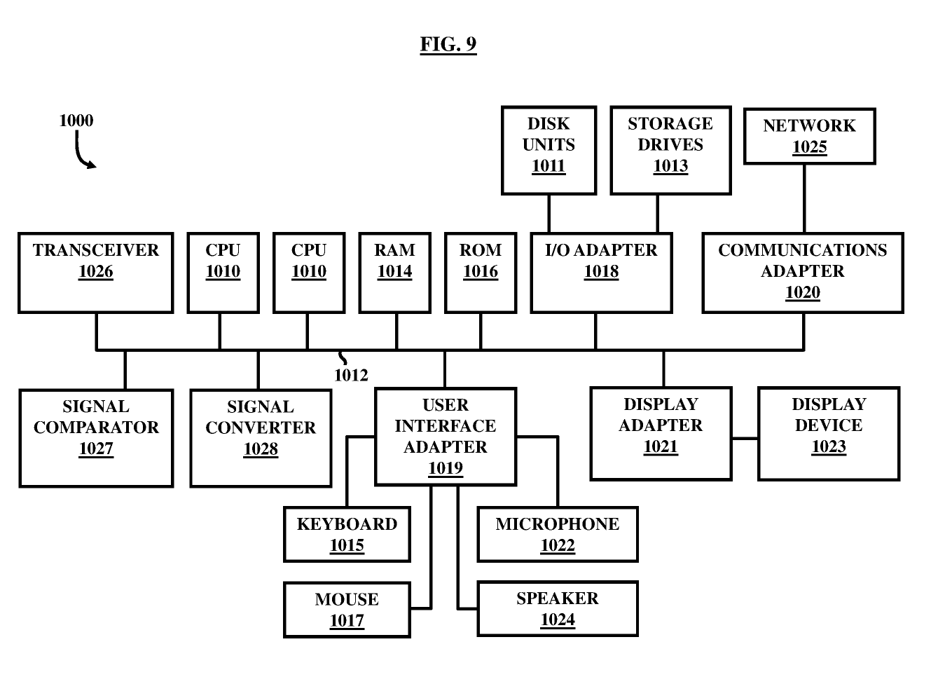

FIG. 8 illustrates an architecture for enabling an authentication mechanism to access digital records stored in the computerized records data-store 114 by the plurality of computer networking systems 124 including the first computer networking system 124a, second computer networking system 124b, and the third computer networking system 124c, based on access rights and association with a particular federated digital community. At least some embodiments for enabling various transactions for accessing the records are discussed herein in conjunction with FIG. 8.

In accordance with an embodiment, the entire ecosystem including such as the information control device 108 and the associated entities and the computer networking systems 124 may be blockchain configured. The blockchain configured information control device 108 may for example provide a private view referred to as private data store 802 so that each entity and/or computer networking facility 124 can privately access and allow others to access certain records as appropriate and authorized based on various policies including community policies. Each of the entities may access the records through the dedicated private store 802 available through a plurality of distributed access points 804 enabled by the distributed blockchain configured single sign on scheme 102 which may be enabled in the form of distributed blocks as shown in FIG. 8, with each block providing a facility to access the blockchain configured computerized records data-store 114 by multiple computer networking facilities 124 at the same time based on defined and granted access rights through the blockchain configured single sign on scheme 102.

The private data store 802 may provide a virtual storage to facilitate interaction, information exchange, and presentation of the digital records according to granted access for a computer networking facility such as 124a. For example, while the blockchain configured computerized records data-store 114 may store entire records in a distributed manner, the private data store 802 allows a virtual storage of only limited records out of the entire records in accordance with permissions granted to the computer networking facility 124a. The virtual view of the records in the private data store 802 may behave like a distributed relational database referencing to the blockchain configured computerized records data-store 114. The private data store 802 may be configured to auto-hash interactions at any required interval. This compartmentalization of the records ensures that the records are secured and private as per access rights authorized to the entities. The data presented on the private data store 802 of the blockchain serves as a secure way to ensure that the private data store 802 is in sync with any permissioned entity's records stored in the blockchain configured computerized records data-store 114.

In an embodiment, the blockchain configured ecosystem 800 may provide a federated blockchain consisting of several computer networking facilities 124 and associated entities that jointly access the records and attempts to process transfers of data through the trusted, secured and distributed single sign on scheme 102.

In accordance with an embodiment, the entities can access the records based on authorization and access rights granted which may dynamically be updated. The blockchain configured identity authorization device 510 may be configured to validate identity of an entity accessing the records to establish a trusted information exchange and interaction. The blockchain configured identity authorization device 810 may utilize a variety of identity validation algorithms and schemes such as but not limited to facial expressions, geographical coordinates, geo-tags, gestures, muscle activity, and the like. In accordance with a specific type of validation scheme utilized by the blockchain identity authorization device 510, a validation scheme-based device may be utilized.

The above description is mainly focused toward a network communication system supporting a computer networking facility. However, in accordance with some embodiments, any other common online entity other than the computer networking facility may also be supported.

In an example, the embodiments herein can provide a computer program product configured to include a pre-configured set of instructions, which when performed, can result in actions as stated in conjunction with the method(s) described above. In an example, the pre-configured set of instructions can be stored on a tangible non-transitory computer readable medium. In an example, the tangible non-transitory computer readable medium can be configured to include the set of instructions, which when performed by a device, can cause the device to perform acts similar to the ones described here.

The embodiments herein may comprise a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments herein is depicted in FIG. 9, with reference to FIGS. 1 through 8. This schematic drawing illustrates a hardware configuration of an information handling/computer system 1000 in accordance with an exemplary embodiment herein. The system 1000 comprises at least one processor or central processing unit (CPU) 1010. The CPUs 1010 are interconnected via system bus 1012 to various devices such as a random access memory (RAM) 1014, read-only memory (ROM) 1016, and an input/output (I/O) adapter 1018. The I/O adapter 1018 can connect to peripheral devices, such as disk units 1011 and storage drives 1013, or other program storage devices that are readable by the system. The system 1000 can read the inventive instructions on the program storage devices and follow these instructions to execute the methodology of the embodiments herein. The system 1000 further includes a user interface adapter 1019 that connects a keyboard 1015, mouse 1017, speaker 1024, microphone 1022, and/or other user interface devices such as a touch screen device (not shown) to the bus 1012 to gather user input. Additionally, a communication adapter 1020 connects the bus 1012 to a data processing network 1025, and a display adapter 1021 connects the bus 1012 to a display device 1023, which provides a GUI (e.g., a gadget) in accordance with the embodiments herein, or which may be embodied as an output device such as a monitor, printer, or transmitter, for example. Further, a transceiver 1026, a signal comparator 1027, and a signal converter 1028 may be connected with the bus 1012 for processing, transmission, receipt, comparison, and conversion of electric or electronic signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A blockchain configured distributed architecture-based system for authenticating access to a computerized records data-store by a plurality of blockchain configured trusted computer networking systems located at remote locations within a blockchain configured computer network, the blockchain configured distributed architecture-based system comprising:
a pre-stored identity information database to store identity information of the plurality of blockchain configured computer networking systems, wherein the plurality of blockchain configured computer networking systems comprise at least a first computer networking system and a second computer networking system such that the first computer networking system is associated with a first entity and is uniquely defined by a first identity information and the second computer networking system is associated with a second entity and is uniquely defined by a second identity information, wherein only the first computer networking system owns a registered digital account with the system and is authorized to access the computerized records data-store;
a pre-stored digital community information database to store federated digital community information of the plurality of blockchain configured computer networking systems identifying whether the plurality of computer networking systems belong to the same federated digital community or different federated digital communities;
an identity authorization device for verifying an identity of the plurality of computer networking systems including verifying the first identity information and the second identity information, the identity authorization device comprising:
a voice recognition device to detect voice inputs from the first entity associated with the first computer networking system and the second entity associated with the second computer networking system during access of the computerized records data-store respectively by the first networking system and the second computer networking system and compare the detected voice inputs with pre-stored voice patterns of the respective first identity information and the second identity information; and
an image recognition device to detect face patterns of the first entity associated with the first computer networking system and the second entity associated with the second computer networking system during access of the computerized records data-store respectively by the first networking system and the second networking system and compare the detected face patterns with pre-stored face patterns of the first identity information and the second identity information;
a processing circuit to authenticate the second computer networking system to access the computerized records data-store upon verification of the second identity information and whether the second computer networking system and the first computer networking system belong to the same federated digital community of the computerized records data-store, even if the second computer networking system does not own a registered digital account with the system; and
a programmatic web interface comprising a single digital sign-on scheme to allow access to the computerized records data-store by the first computer networking system and the second computer networking system after verification of the first identity information and the second identity information respectively and upon verification that the second computer networking system and the first computer networking system belong to the same federated digital community of the computerized records data-store,
wherein said processing circuit transforms the accessed computerized records into a digital data structure readable by a scanner.

2. The system of claim 1, wherein the federated digital community is defined by a trusted computerized group of digitally stored computer executable profiles associated with a social networking server such that each such digitally stored computer executable profile is associated with at least one of the plurality of blockchain configured trusted computer networking systems associated with an entity and uniquely identifiable by its identity information.

3. The system of claim 1, wherein the processing circuit is configured to:
allow access to the first computer networking system upon verification of the first identity information indicative of an authorized access to the computerized records data-store, wherein the first identity information is linked to the registered account authorizing access to the computerized records data store and owned by the first computer networking system associated with the first entity; and
allow access to the second computer networking system upon verification of the second identity information simply because the first computer networking system is already allowed to access the computerized records data-store and the first computer networking system and the second computer networking system are part of the same federated digital community, wherein the second computer networking system does not own a registered account with the system which is to authorize access to the computerized records data store.

4. The system of claim 3, wherein the registered account with the system owned by the first computer networking system is defined by a secured encrypted login credential information containing a unique digital identifier indicative of a registered access to the computerized records data-store.

5. The system of claim 4, wherein the login credential information associated with the first computer networking system of the first entity is integrated within the first identity information so as the first identity information to also verify the login credential information of the registered account with the system.

6. The system of claim 2, wherein the blockchain configured computer network comprises a first arbitrarily large number of blockchain configured computer networking systems of the plurality of blockchain configured computer networking systems and the federated digital community comprises a second arbitrarily large number of blockchain configured computer networking systems such that each such blockchain configured computer networking system of the second arbitrarily large number of blockchain configured computer networking systems is associated with a digitally stored computer executable profile indicative of a unique identity.

7. The system of claim 6, wherein the digitally stored computer executable profile is accessible through a unique social digital login credential of a computer networking system.

8. The system of claim 7, wherein the unique social digital login credential of a computer networking system together with an identity information of an associated entity allows access to the computer records data-store upon verification by the identity authorization device, wherein the identity authorization device further comprising a social digital identity verification device such that the social digital identity verification device is configured to verify the social digital login credential of the computer networking system via the social networking server communicatively coupled to a third party network.

9. The system of claim 1, further comprising a set of computer executable rules configured to be executed by the processing circuit to associate one or more of the plurality of computer networking systems within a federated digital community.

10. The system of claim 1, wherein the voice recognition device comprising:
a communication interface that communicates with an external device;
a hardware-based sound card including or coupled to an external microphone that collects sound to produce audio data;
a voice recognition software to execute speech recognition instructions; and
a microcontroller to analyze the audio data based on the speech recognition instructions and generate a signal indicative of the voice inputs.

11. The system of claim 1, wherein the image recognition device comprising:
a communication interface that communicates with an external device;
a hardware-based image acquisition device including a camera that collects an image from a live stream in the external device;
an image segmentation device that breaks the image into a plurality of segmented portions; and
a processor to analyze each of the segmented portions and generate a signal indicative of the face patterns.

12. The system of claim 1, wherein said first computer networking system comprises a mobile communication device.

13. The system of claim 1, wherein said second computer networking system comprises a mobile communication device.

14. The system of claim 1, wherein said identity authorization device comprises a mobile communication device.

15. The system of claim 1, wherein said digital data structure comprises a QR (quick response) code.

16. The system of claim 1, wherein said first computer networking system comprises a cloud-based architecture.

17. The system of claim 1, wherein said second computer networking system comprises a cloud-based architecture.

18. The system of claim 1, wherein said processing circuit transforms the accessed computerized records into a multi-media format presented on a display device.

19. The system of claim 1, wherein said processing circuit transforms the accessed computerized records into an audio format output by a speaker.

20. The system of claim 1, wherein said scanner comprises a mobile communication device.
